(19) United States
(12) Patent Application Publication
(10) Pub. No.: US 2010/0039827 A1
(43) Pub. Date: Feb. 18, 2010

(54) Secondary Optic Lens

(76) Inventor: Xuliang Li, Dongguan City (CN)

Correspondence Address: Anita Yu, Flat F, 23/F, Block 1,, Kam Fung Garden, 458 Castle Peak Road,, Tsuen Wan, omitted

(21) Appl. No.: 12/525,545

(22) PCT Filed: Jun. 16, 2008
(86) PCT No.: PCT/CN2008/001152

§ 371 Date: Aug. 2, 2009

(30) Foreign Application Priority Data
Oct. 16, 2007 (CN) 200720172454.2

(51) Int. Cl. F21V 5/04

(52) U.S. Cl. 362/335

(57) ABSTRACT

A secondary optical lens (105) includes a base plane (1054), a light incident surface (1053), a light emitting surface (1055), and two fasteners (1052). The light incident surface (1053) is a concave surface and is located in the center of the base plane (1054). The light emitting surface (1055) is formed by two partial spherical surfaces and a transition surface between the two partial spherical surfaces. The light emitting surface (1055) is connected to the base plane (1054) and defines the boundary of the base plane (1054). The two fasteners (1052) are respectively disposed at two edges of the base plane (1054) in a longitudinal direction.

### BACKGROUND OF THE INVENTION

1. Field of Invention

The present invention relates to the field of light-emitting diode (LED) illumination technology, and more particularly to a secondary optical lens for an LED street lamp.

2. Related Art

In the LED illumination technology, in order to improve the light-exiting efficiency of an LED and promote the convenience in use, an LED chip generally needs to be packaged once, for example, in a manner of packaging a spherical lens. For specific applications where the lights are required to be condensed to form a desired light spot, such as the LED street lamp illumination, a secondary optical processing needs to be performed on the packaged LED chip (generally referred to as an LED bulb). A secondary optical processing method in the prior art includes additionally disposing a common secondary lens in front of a set of LED bulbs, so as to condense the lights. When the above method is adopted for secondary processing, a preset distance must be maintained between the LED bulbs and the secondary lens, so that the lights entering the secondary lens are stray lights, which results in a low light-exiting efficiency of the secondary optical processing operation. Meanwhile, as the lights entering the secondary lens are stray lights, it is difficult to control the shape of the output light spot.

### SUMMARY OF THE INVENTION

In order to overcome the above defects of the prior art, the present invention is directed to a secondary optical lens, which has a high light-exiting efficiency and easily controls the shape of an output light spot of a lighting device.

The objectives of the present invention may be achieved through the following technical solution.

A secondary optical lens includes a base plane, a light incident surface, and a light emitting surface. The base plane is a plane. The light emitting surface is formed by two partial spherical surfaces and a transition surface between the two partial spherical surfaces. The light emitting surface is connected to the base plane and defines the boundary of the base plane. The light incident surface is a concave surface and is located in the center of the base plane. The base plane, the light incident surface, and the light emitting surface jointly define a body of the secondary optical lens. The secondary optical lens further includes a pair of fasteners disposed at a body base plane, and the fasteners are respectively disposed at two longitudinal edges of the base plane. Each fastener has a hook extending longitudinally along the base plane and extending out of the base plane. A front surface of the hook facing the light emitting surface is a first plane parallel to the base plane, and a back surface of the hook away from the light emitting surface is a second plane. The second plane is an inclined surface relative to the first plane, and one end of the second plane extending out of the base plane is a lower end.

In the secondary optical lens, the transition surface includes a linear-tangential transition area on the top of the light emitting surface and circular-arc transition areas on side surfaces of the light emitting surface.

In the secondary optical lens, the circular-arc transition areas are formed between a top surface and two side surfaces of the light emitting surface.

In the secondary optical lens, the light incident surface is a semispherical concave surface.

In the secondary optical lens, the light incident surface is a smooth-transition concave surface.

The secondary optical lens is made of polyvinyl chloride (PVC), acrylonitrile butadiene styrene (ABS), or polypropylene (PP) by injection molding, and both the light incident surface and the light emitting surface have a polished layer.

In the secondary optical lens, the transition surface includes a linear-tangential transition area on the top of the light emitting surface and circular-arc transition areas on side surfaces of the light emitting surface; the circular-arc transition areas are formed between a top surface and two side surfaces of the light emitting surface; the light incident surface is a semispherical concave surface; and the secondary optical lens is made of PVC, ABS, or PP by injection molding, and both the light incident surface and the light emitting surface have a polished layer.

The objectives of the present invention may also be achieved through the following technical solution.

A secondary optical lens includes a base plane, a light incident surface, and a light emitting surface. The base plane is a plane. The light emitting surface is formed by two partial spherical surfaces and a transition surface between the two partial spherical surfaces. The light emitting surface is connected to the base plane and defines the boundary of the base plane. The light incident surface is a concave surface and is located in the center of the base plane. The base plane, the light incident surface, and the light emitting surface jointly define a body of the secondary optical lens. The secondary optical lens further includes a pair of fasteners disposed at a body base plane, and the fasteners are respectively disposed at two longitudinal edges of the base plane. Each fastener has a hook extending longitudinally along the base plane and extending out of the base plane. A front surface of the hook facing the light emitting surface is a plane parallel to the base plane, and a back surface of the hook away from the light emitting surface is a cambered surface. One end of the cambered surface extending out of the base plane is lower than the other end of the cambered surface.

In the secondary optical lens, the transition surface includes a linear-tangential transition area on the top of the light emitting surface and circular-arc transition areas on side surfaces of the light emitting surface; the circular-arc transition areas are formed between a top surface and two side surfaces of the light emitting surface; the light incident surface is a semispherical concave surface; and the secondary optical lens is made of PVC, ABS, or PP by injection molding, and the light incident surface and the light emitting surface both have a polished layer.

In the secondary optical lens of the present invention, the base plane, the light incident surface, and the light emitting surface jointly define the body of the secondary optical lens. The light incident surface is a concave surface and is located in the center of the base plane, and may be seamlessly fitted with a top portion of a primary lens. As an LED chip itself has a desirable light-condensing property, and a light exit portion of the primary lens is basically the top portion of the primary lens, all the lights exiting from the primary lens directly become incident lights of the secondary lens, without undergoing any intermediate process. When the primary lens and the secondary lens are made of the same material, the loss caused by secondary refraction and the stray loss are reduced, as compared with the prior art. Therefore, the secondary optical lens of the present invention can guide lights more directly, and has a high light-exiting efficiency. The secondary optical lens further includes a pair of fasteners disposed at a body base plane, and the fasteners are respectively disposed at two longitudinal edges of the base plane. In use, an LED bulb is generally disposed on a heat-conductive substrate, and the fasteners in the present invention are used to fasten the heat-conductive substrate. Fastening holders of the heat-conductive substrate may also be designed as elastic ones, so as to provide a certain adhesive force between the secondary optical lens and the LED bulb, thus ensuring the seamless fitting effect between the primary lens and the secondary optical lens. As the secondary optical lens of the present invention is designed for one LED bulb, the number of secondary optical lenses to be disposed should be consistent with the number of LED bulbs disposed in an LED lighting device. Therefore, when the lighting device is designed, an output light spot of each secondary optical lens may be controlled separately. Hence, the output light spot of the lighting device can be controlled more easily, as compared with the lighting device having only one secondary lens in the prior art.

### BRIEF DESCRIPTION OF THE DRAWINGS

FIG. 1 is a front view of a first embodiment of the present invention.

FIG. 2 is a sectional view taken along Line A-A in FIG. 1.

FIG. 3 is a sectional view taken along Line B-B in FIG. 1.

FIG. 4 is a side view of the first embodiment of the present invention.

FIG. 5 is a three-dimensional view of the first embodiment of the present invention.

FIG. 6 is a three-dimensional view of the first embodiment of the present invention, viewed from a direction different from that of FIG. 5.

FIG. 7 shows lights emitted by the first embodiment of the present invention at the section as shown in FIG. 3.

FIG. 8 shows lights emitted by the first embodiment of the present invention at the section as shown in FIG. 2.

FIG. 9 is a schematic view of a second embodiment of the present invention.

FIG. 10 is an exploded schematic view of the second embodiment of the present invention.

FIG. 11 is a schematic view of a work module of the second embodiment of the present invention.

FIG. 12 is an exploded schematic view of a work module of the second embodiment of the present invention.

FIG. 13 is a light distribution curve of a third embodiment of the present invention.

FIG. 14 shows a rectangular coordinate representation of the light distribution curve in FIG. 13.

### DETAILED DESCRIPTION OF THE INVENTION

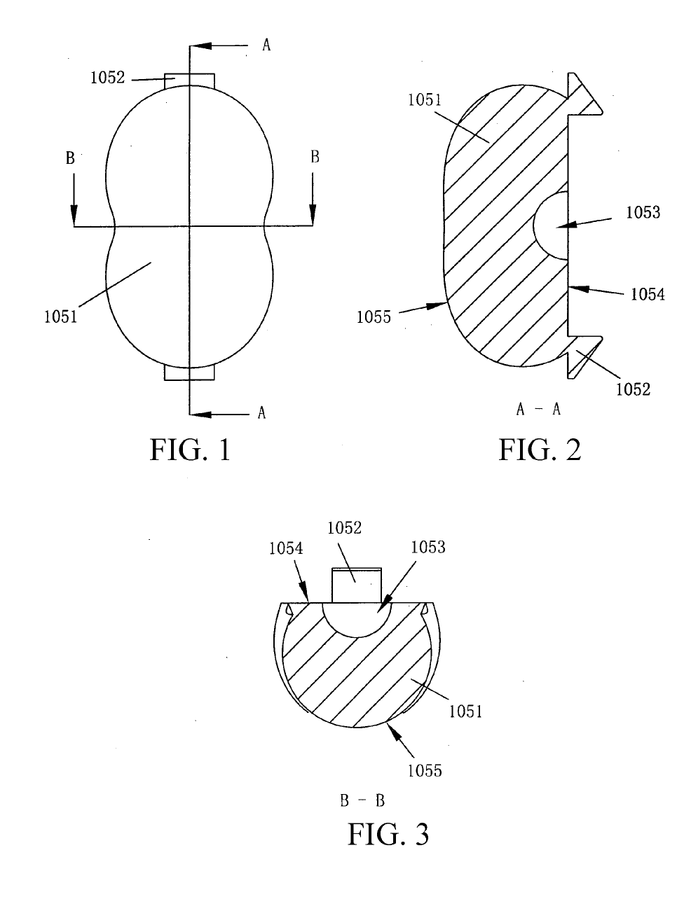

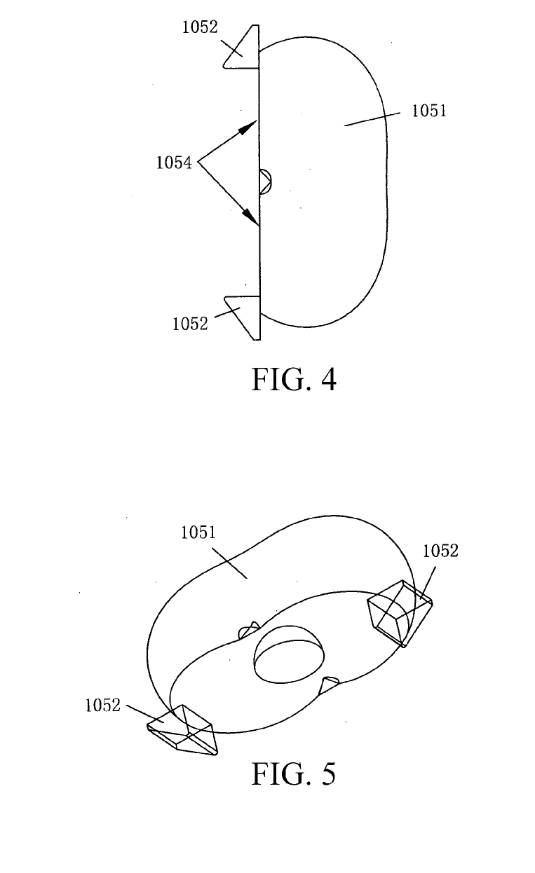

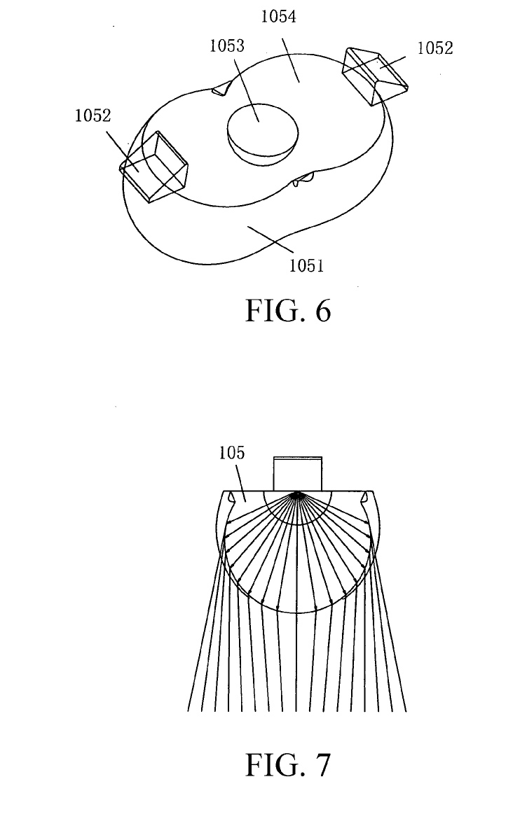

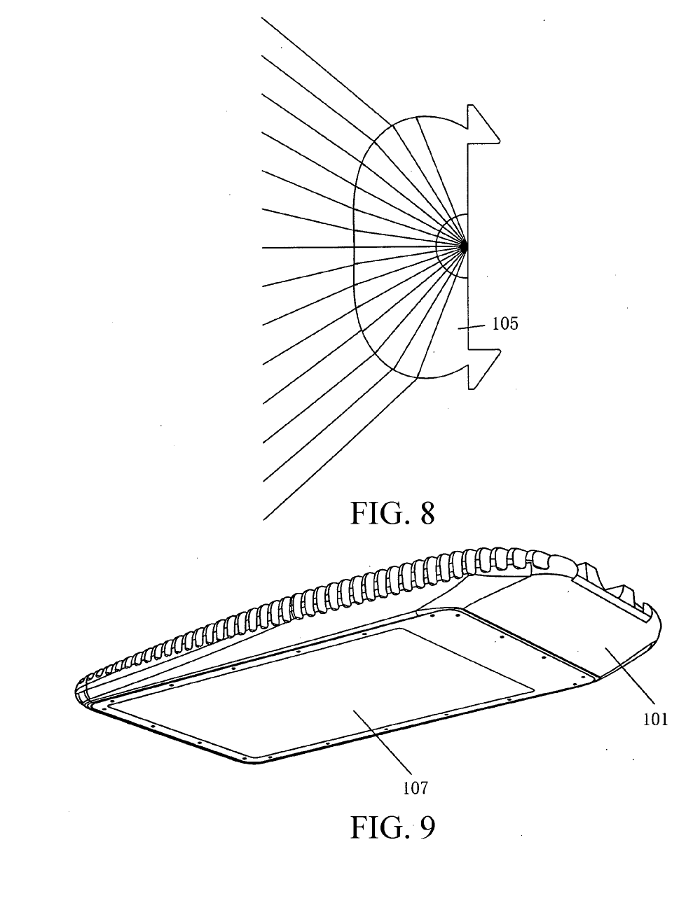

The present invention is further described in detail below with reference to the accompanying drawings. Referring to FIGS. 1 to 6, in a first embodiment of the present invention, a secondary optical lens 105 is provided, which includes a base plane 1054, a light incident surface 1053, and a light emitting surface 1055. The base plane 1054 is a plane. The light emitting surface 1055 is formed by two partial spherical surfaces and a transition surface between the two partial spherical surfaces. The light emitting surface 1055 is connected to the base plane 1054 and defines the boundary of the base plane 1054. The light incident surface 1053 is a concave surface and is located in the center of the base plane 1054. The base plane 1054, the light incident surface 1053, and the light emitting surface 1055 jointly define a body 1051 of the secondary optical lens 105. The secondary optical lens 105 further includes a pair of fasteners 1052 disposed at a body base plane 104, and the fasteners 1052 are respectively disposed at two longitudinal edges of the base plane 1054. Each fastener 1052 has a hook extending longitudinally along the base plane 1054 and extending out of the base plane 1054. A front surface of the hook facing the light emitting surface 1055 is a plane parallel to the base plane 1054, and a back surface of the hook away from the light emitting surface 1055 is an inclined surface relative to the plane, and one end of the inclined surface extending out of the base plane 1054 is a lower end. Referring to FIGS. 1 to 6 again, the transition surface includes a linear-tangential transition area on the top of the light emitting surface 1055 and circular-arc transition areas on side surfaces of the light emitting surface 1055, and the circular-arc transition areas are formed between a top surface and two side surfaces of the light emitting surface 1055. In this embodiment, the light incident surface 1053 is a semispherical concave surface, and has the same diameter as a spherical lens of an LED bulb that is used together. The secondary optical lens 105 is made of ABS by injection molding, and accordingly, the correspondingly-used spherical lens of the LED bulb is made of the same ABS material. Both the light incident surface 1053 and the light emitting surface 1055 have a polished layer. FIGS. 7 and 8 explicitly show lights emitted by this embodiment from a cross section and a longitudinal section respectively.

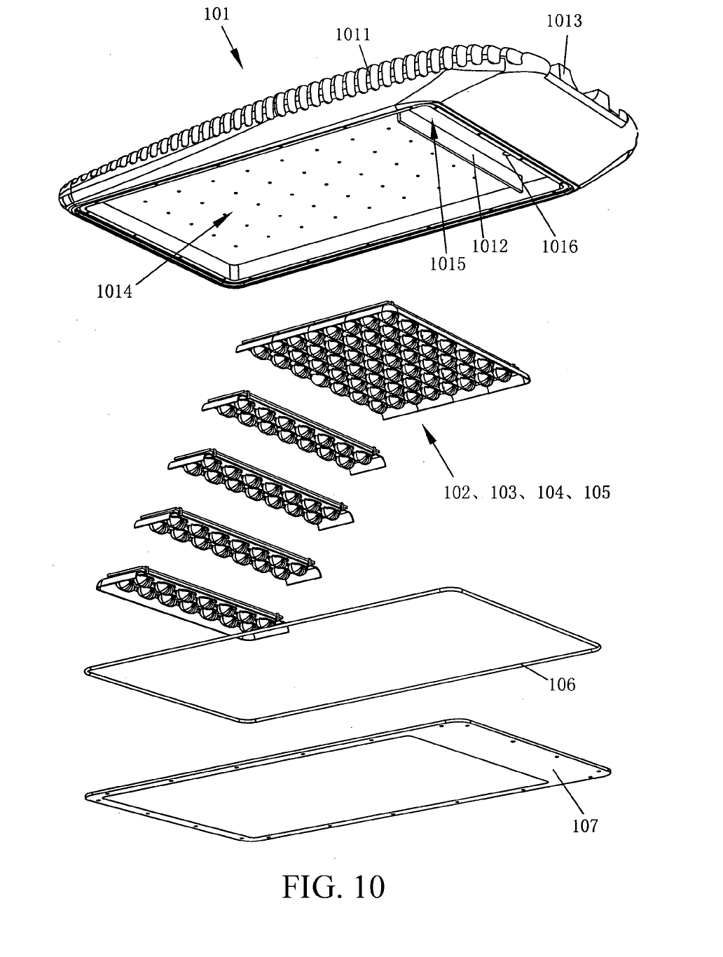

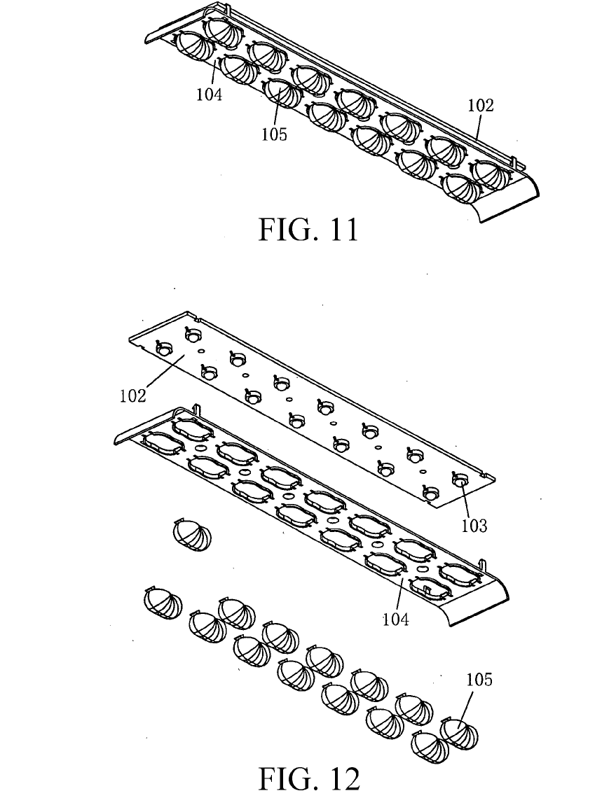

A second embodiment of the present invention is an LED street lamp, which is an application of the first embodiment of the present invention. Referring to FIGS. 9 to 12, the LED street lamp includes a lamp body 101 and LED bulbs 103. The lamp body 101 has a front surface and a back surface. A chamber defined by side plates and a bottom surface is formed on the front surface of the lamp body 101. Heat sink fins 1011 are disposed on the back surface of the lamp body. A lamp post connecting mechanism is further disposed at one end of the back surface of the lamp body. The lamp post connecting mechanism includes two clamping blocks each having a circular-arc concave surface. The lower clamping block 1013 is disposed on the back surface of the lamp body 101 and serves as a portion of the lamp body 101. The upper clamping block (not shown) is disposed independently. The circular-arc concave surfaces of the upper clamping block and the lower clamping block 1013 are disposed facing each other. The upper clamping block is connected to the lower clamping block 1013 by screws. A lamp post is disposed between the circular-arc concave surface of the upper clamping block and the circular-arc concave surface of the lower clamping block 1013. A plane is formed at the bottom of the chamber, and a baffle plate 1012 is further disposed in the chamber. The baffle plate 1012 is disposed close to one end where the lamp post connecting mechanism is located, and further divides the chamber into two parts, that is, a secondary chamber 1015 close to the end where the lamp post connecting mechanism is located and a main chamber 1014 on the other side of the baffle plate. Gaps that communicate the main chamber 1014 with the secondary chamber 1015 are formed between two ends of the baffle plate 1012 and side walls of the chamber. The LED street lamp further includes an LED array plate. The LED array plate includes LED bulbs 103 of a heat-conductive substrate 102. The heat-conductive substrate 102 is provided with printed circuits thereon. The LED bulbs 103 are disposed on one surface of the heat-conductive substrate 102. The LED street lamp further includes secondary optical lenses 105 disposed on a lens substrate 104. The lens substrate 104 is disposed in parallel with the heat-conductive substrate 102. Each LED bulb 103 is corresponding to one secondary optical lens 105. Several supporting portions (not shown) with the same height are disposed on one side of the lens substrate 104 facing the heat-conductive substrate 102. The supporting portions press against the heat-conductive substrate 102, and define a distance between the lens substrate 104 and the heat-conductive substrate 102. In this embodiment, the supporting portions are ribs, and the contact surfaces between the ribs and the heat-conductive substrate 102 are planes. The ribs pass through openings of the lens substrate 104 and the heat-conductive substrate 102 that are used for connecting to the lamp body 101. Each of the openings of the lens substrate 104 is formed with a counter bore, and the counter bore is disposed on one surface away from the heat-conductive substrate 102. Referring to FIG. 12, the lens substrate 104 of this embodiment is further provided with fastening holders, and the heat-conductive substrate 102 is further provided with recesses, so as to pre-assemble the lens substrate 104 to the heat-conductive substrate 102. The side plate of the lamp body 101 is provided with a step on an inner side of one end away from the bottom surface of the chamber. The LED street lamp further includes a lamp shade 107. The lamp shade 107 is disposed within the step of the side plate of the lamp body 101 by using screws. In this way, the lamp shade 107 and the lamp body 101 constitute a sealed chamber. A gasket 106 is further disposed at the junction between the lamp shade 107 and the lamp body 101. The lamp body 101 is made of a heat-conductive metal material. A wire hole 1016 for communicating to the back surface is further formed on a bottom surface of the secondary chamber 1015 of the lamp body 101. Referring to FIG. 12, one LED array plate is formed by several LED sub-array plates, and each LED sub-array plate is provided with a set of LED bulbs. Similarly, the lens substrate is formed by several lens sub-plates, and each lens sub-plate is provided with a set of secondary optical lenses. The number and positions of the secondary optical lenses are corresponding to that of the LED bulbs on the corresponding heat-conductive substrate. Referring to FIGS. 11 and 12, one LED sub-array plate combined with one lens substrate disposed with secondary optical lenses constitutes a work module. The lamp shade 107 is a transparent acrylic board. A nontransparent silk-screened layer is disposed on a surface of the acrylic board, and the silk-screened layer is close to the peripheries of the acrylic board. A light-transmissive region where no silk-screened layer is disposed is further formed on the surface of the acrylic board, and the silk-screened layer is disposed around the light-transmissive region. In this embodiment, a commercially available waterproof contact is further disposed at the wire hole 1016. The top ends of the heat sink fins 1011 at the back surface of the lamp body 101 constitute a cambered surface, and the height of the heat sink fins 1011 in a region opposite to the center of the LED array plate is greater than that of the heat sink fins 1011 in the other regions. As such, a beautiful appearance and a highly-efficient heat dissipation function are both achieved. As the LED bulbs 103 are most densely distributed in the center of the LED array plate, and a lot of heat is generated during operation, a larger heat dissipation area is required. The lamp body 101 is made of an aluminum alloy through die casting.

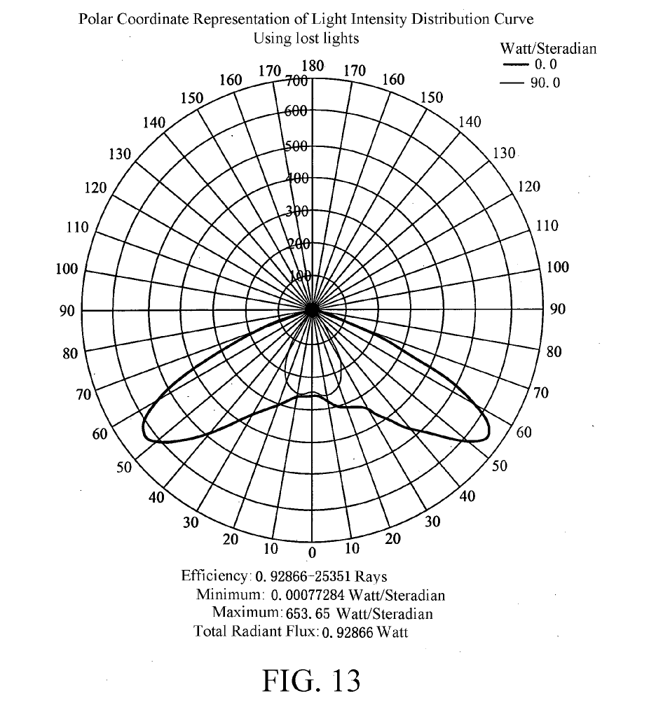

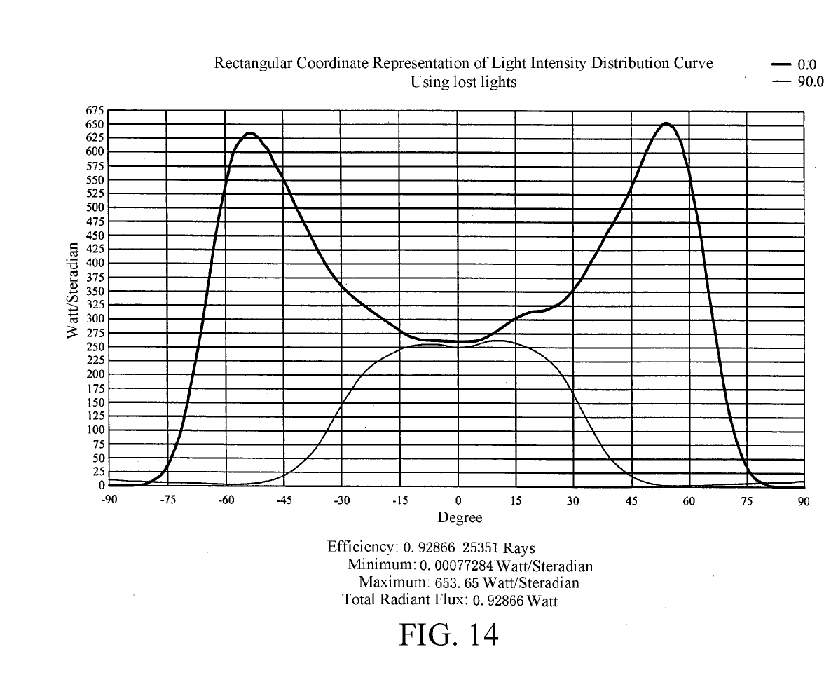

A third embodiment of the present invention is an example of the design and optical validation of the secondary optical lens. It is assumed that the light exiting requirements of the lens are as shown by a light distribution curve in FIG. 13. FIG. 13 is a polar coordinate representation of the light distribution curve. The origin (center of concentric circles) of the polar coordinate graph represents the center of the light emitting surface of the secondary optical lens. Each concentric circle represents a light intensity. The larger the concentric circle is, the greater the light intensity will be. Each angle shown in the figure is a perpendicular angle on the corresponding section, and the downward direction is defined as 0°. FIG. 14 is a rectangular coordinate representation of FIG. 13. As seen from the light distribution curve that, the desired light spot is a rectangular one. Based on the principle of refraction and designing experience, it can be known that a desired shape of the secondary optical lens is the shape of the secondary optical lens in the first embodiment of the present invention. The lens in the first embodiment of the present invention is used for validation, and a rectangular light spot is obtained, which indicates that the designing objective of the secondary optical lens is achieved.

A fourth embodiment of the present invention is also a secondary optical lens. The difference between this embodiment and the first embodiment of the present invention lies in that, the inclined surface at the back of each fastener is a cambered surface rather than a plane, such that the secondary optical lens can easily slide into the heat-conductive substrate during assembly.

### INDUSTRIAL APPLICABILITY

The above embodiments are merely preferred embodiments of the present invention. Any equivalent variation made to the technical features without departing from the claims of the present invention fall within the scope of the present invention as defined by the appended claims.

What is claimed is:

1. A secondary optical lens, comprising: a base plane, a light incident surface, and a light emitting surface, wherein the base plane is a plane; the light emitting surface is formed by two partial spherical surfaces and a transition surface between the two partial spherical surfaces; the light emitting surface is connected to the base plane and defines a boundary of the base plane; the light incident surface is a concave surface and is located in a center of the base plane; the base plane, the light incident surface, and the light emitting surface jointly define a body of the secondary optical lens; the secondary optical lens further comprises a pair of fasteners disposed at a body base plane, the fasteners are respectively disposed at two longitudinal edges of the base plane; each fastener has a hook extending longitudinally along the base plane and extending out of the base plane, a front surface of the hook facing the light emitting surface is a first plane parallel to the base plane, a back surface of the hook away from the light emitting surface is a second plane, the second plane is an inclined surface relative to the first plane, and one end of the second plane extending out of the base plane is a lower end.

2. The secondary optical lens according to claim 1, wherein the transition surface comprises a linear-tangential transition area on a top of the light emitting surface and circular-arc transition areas on side surfaces of the light emitting surface.

3. The secondary optical lens according to claim 2, wherein the circular-arc transition areas are formed between a top surface and two side surfaces of the light emitting surface.

4. The secondary optical lens according to claim 1, wherein the light incident surface is a semispherical concave surface.

5. The secondary optical lens according to claim 1, wherein the light incident surface is a smooth-transition concave surface.

6. The secondary optical lens according to claim 1, wherein the secondary optical lens is made of polyvinyl chloride (PVC), acrylonitrile butadiene styrene (ABS), or polypropylene (PP) by injection molding, and both the light incident surface and the light emitting surface have a polished layer.

7. The secondary optical lens according to claim 1, wherein the transition surface comprises a linear-tangential transition area on a top of the light emitting surface and circular-arc transition areas on side surfaces of the light emitting surface; the circular-arc transition areas are formed between a top surface and two side surfaces of the light emitting surface; the light incident surface is a semispherical concave surface; and the secondary optical lens is made of polyvinyl chloride (PVC), acrylonitrile butadiene styrene (ABS), or polypropylene (PP) by injection molding, and both the light incident surface and the light emitting surface have a polished layer.

8. A secondary optical lens, comprising: a base plane, a light incident surface, and a light emitting surface, wherein the base plane is a plane; the light emitting surface is formed by two partial spherical surfaces and a transition surface between the two partial spherical surfaces; the light emitting surface is connected to the base plane and defines a boundary of the base plane; the light incident surface is a concave surface and is located in a center of the base plane; the base plane, the light incident surface, and the light emitting surface jointly define a body of the secondary optical lens; the secondary optical lens further comprises a pair of fasteners disposed at a body base plane, the fasteners are respectively disposed at two longitudinal edges of the base plane; each fastener has a hook extending longitudinally along the base plane and extending out of the base plane, a front surface of the hook facing the light emitting surface is a plane parallel to the base plane, a back surface of the hook away from the light emitting surface is a cambered surface, and one end of the cambered surface extending out of the base plane is lower than the other end of the cambered surface.

9. The secondary optical lens according to claim 8, wherein the transition surface comprises a linear-tangential transition area on a top of the light emitting surface and circular-arc transition areas on side surfaces of the light emitting surface; the circular-arc transition areas are formed between a top surface and two side surfaces of the light emitting surface; the light incident surface is a semispherical concave surface; the secondary optical lens is made of polyvinyl chloride (PVC), acrylonitrile butadiene styrene (ABS), or polypropylene (PP) by injection molding, and both the light incident surface and the light emitting surface have a polished layer.
